(19) United States
(12) Patent Application Publication
(10) Pub. No.: US 2010/0261046 A1
(43) Pub. Date: Oct. 14, 2010

(54) Heat Exchanger Unit and Electrochemical Energy Accumulator with a Heat Exchanger Unit

(75) Inventors: Johann German, Weinstadt (DE); Wolfgang Warthmann, Weinstadt (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/677,483

(22) PCT Filed: Aug. 30, 2008
(86) PCT No.: PCT/EP2008/007113

§ 371 Date: Jun. 18, 2010

(30) Foreign Application Priority Data
Sep. 11, 2007 (DE) 10 2007 044 461.5

(51) Int. Cl. H01M 10/50; F28D 15/00

(52) U.S. Cl. 429/120; 165/104.33; 165/104.31; 165/104.21

(57) ABSTRACT

A heat exchanger unit for an electrochemical energy accumulator, comprising flow channels, through which a temperature control medium flows. Ends of the flow channels are provided with flow distributor channels, which supply the flow channels, and/or return flow collection channels, and which collect the medium. A flow distributor is connected upstream of the flow distributor channels and a return flow collector is connected downstream of the return flow collection channels. The flow distributor and the return flow collector are separated from, and lie opposite, each other. A supply opening is located centrally on one of the lateral surfaces of the flow distributor and a drain opening is located centrally, on one of the lateral surfaces of the return flow collector.

The invention relates to a heat exchanger unit according to the preamble of claim 1 and an electrochemical energy accumulator according to the preamble of claim 13.

Modern electrochemical high performance energy accumulators (also called high performance batteries in short), as for example nickel metal hydride batteries, lithium ion batteries or the like, require a corresponding battery management and an efficient temperature control of the single electrochemical storage cells (also called single cells), so as to ensure a performance of the electrochemical energy accumulator as good as possible and to prevent damage.

These electrochemical energy accumulators are for example known from DE 10 2004 005 393 A1 and from DE 10 2006 015 568 B3. The electrochemical energy accumulators described there have a heat exchanger unit, between whose heat exchanger channels (also called flow channels) are arranged several single cells next to each other respectively in at least two adjacent rows, wherein the flow channels are flown through with an alternating flow direction in one plane and over several planes, whereby a more homogeneous of the single cells is enabled.

The homogeneous temperature control is thereby limited to the temperature control of the single cells amongst each other. The respective single cell itself is subjected to a temperature increase or a gradient in the flow direction between the flow distributor channels and the return flow collector channels by connection of the flow channels.

The invention is thus based on the object to give a heat exchanger unit for an electrochemical energy accumulator which enables an improved homogeneous temperature control of the single cells compared to the state of the art. Furthermore, an electrochemical energy accumulator with improved cooling is to be given and an especially suitable use of the electrochemical energy accumulator.

The object regarding the heat exchanger unit is solved according to the invention by the characteristics given in claim 1. Regarding the electrochemical energy accumulator, the object is solved according to the invention by the characteristics given in claim 14.

Advantageous developments of the invention are the subject of the dependent claims.

The heat exchanger unit for an electrochemical energy accumulator according to the invention comprises flow channels (also called heat exchanger or circulation channels), through which a temperature control medium flows, which are provided on their end side with flow distributor channels or return flow collection channels which supply these and/or collect from these. For supplying or discharging the temperature control medium, a flow distributor is connected upstream of the flow distributor channels, and a return flow collector is connected downstream of the return flow collection channels. The flow distributor and the return flow collector are thereby arranged separate from each other and are opposite to one another, wherein a supply opening is located centrally on one of the lateral surfaces of the flow distributor, and a drain opening is located centrally on one of the lateral surfaces of the return flow collector.

By means of such an arrangement of the supply opening and the drain opening, which are spatially separated on the one hand, which are opposite each other, and a central arrangement of the supply opening, that is, around a common center or in the common center point of one of the lateral surfaces of the flow distributor or of the return flow collector, of the supply opening and drain opening, an even symmetrical distribution or collection of the temperature control medium, especially cooling medium, is enabled on all flow distributor channels and from all return flow collection channels. Such a symmetrical distribution or collection of the temperature control medium enables a very efficient and effective cooling and coolant distribution over the especially wave-shaped flow channels. Such a heat exchanger unit is also called wave guide cooler. Furthermore, a very compact construction of the heat exchanger unit is enabled.

The flow distributor and the return flow collector extend laterally at the outer flow channels in a possible embodiment opposite each other over the entire length of the flow channels. In other words: the flow distributor and the return flow collector extend parallel to the longitudinal extension of the flow channels, wherein the temperature control medium is supplied or discharged with a flow direction transverse to the longitudinal extension of the flow channels and is deflected in the flow distributor or the return flow collector and guided in the flow distributor or return flow collector with a flow direction extending parallel to the longitudinal extension of the flow channels. Guide or deflection elements can thereby be arranged in the supply opening or drain opening for the symmetrical distribution and efficient guidance.

Preferably, a center guide element is respectively arranged in the supply or drain opening, especially a center guide plate in the flow direction of the supply and drain opening or perpendicular to the flow direction in the flow distributor or return flow collector. The temperature control medium to be supplied or discharged is hereby divided or collected symmetrically in a simple and secure manner, so that swirls and undesired flow resistances are securely reduced or avoided.

The flow distributor and the return flow collector are conveniently respectively formed as one channel. The flow distributor and the return flow collector are preferably formed rectangular in their cross section. This is especially simple and cost-efficient for the manufacture.

The flow distributor and the return flow collector are themselves formed in a funnel- or cone-shaped manner for an especially homogeneous supply and discharge of the temperature control medium. The flow distributor and the return flow collector are respectively formed as a single flat channel for this, whose channel width approximately corresponds to the height of the heat exchanger unit and whose channel length approximately corresponds to the length of the heat exchanger unit and whose channel height varies along the longitudinal extension. The channel height of the respective flat channel thereby preferably increases from the respective channel end to the channel center, so that a funnel shape is formed. Conveniently, the supply opening is thereby arranged in the channel center of the flow distributor, and the drain opening is arranged in the region of the channel center of the return flow collector.

In an alternative embodiment to the funnelshaped flow distributor and funnel-shaped return flow collector, the flow distributor and the return flow collector are respectively formed as a flat channel with a constant channel height and varying channel width, wherein the supply opening opens into the flow distributor or the drain opening exits from the return flow collector in the channel center perpendicular to the channel progression. The supply opening or the drain opening are themselves respectively formed in the shape of a funnel for a homogeneous supply opening and drain opening of the temperature control medium.

An evaporator is arranged on the flow input side for an efficient temperature control, especially cooling of the temperature control medium. A blower, especially an axial flow fan is conveniently connected downstream in the drain opening for the efficient discharge of the heated temperature control medium on the flow output side.

With regard to the electrochemical energy accumulator with the described heat exchanger unit, several electrochemical storage cells are arranged in such a manner that they are largely entirely surrounded by the heat exchanger unit. The flow channels are preferably formed in a wave-shaped manner for a form to be adapted to the round single or storage cells of the energy accumulator to be temperature-controlled, especially cooled. The storage cells can also be formed in a prismatic manner.

A gaseous medium, especially air, is especially used as temperature control medium. A fluid medium, especially a cooling medium such as water can alternatively also be used.

In a further embodiment, the heat exchanger unit which is also called air cooler with air cooling, and water cooler with water cooling, simultaneously serves for the cooling of an electronics unit for controlling and/or regulating and monitoring the charging and discharging process. In other words: the electronics unit and the storage cells of the energy accumulator are cooled simultaneously and together by means of the heat exchanger unit. The electronics unit is for example arranged in the region of the supply opening for this. For controlling and/or regulating and monitoring the charging and discharging process of the energy accumulator, corresponding sensors, as for example temperature sensors, voltage sensors, current sensors, are furthermore arranged at the or in the energy accumulator, especially in the region of the flow channels.

The electrochemical energy accumulator is preferably used for the board current supply of a vehicle and/or for the current supply of a drive device of a vehicle. The vehicle is conveniently a road vehicle having one or several types of drive (=hybrid drive), one of which comprises an electric drive.

Embodiments of the invention are explained in more detail in the following by means of a drawing. It shows thereby:

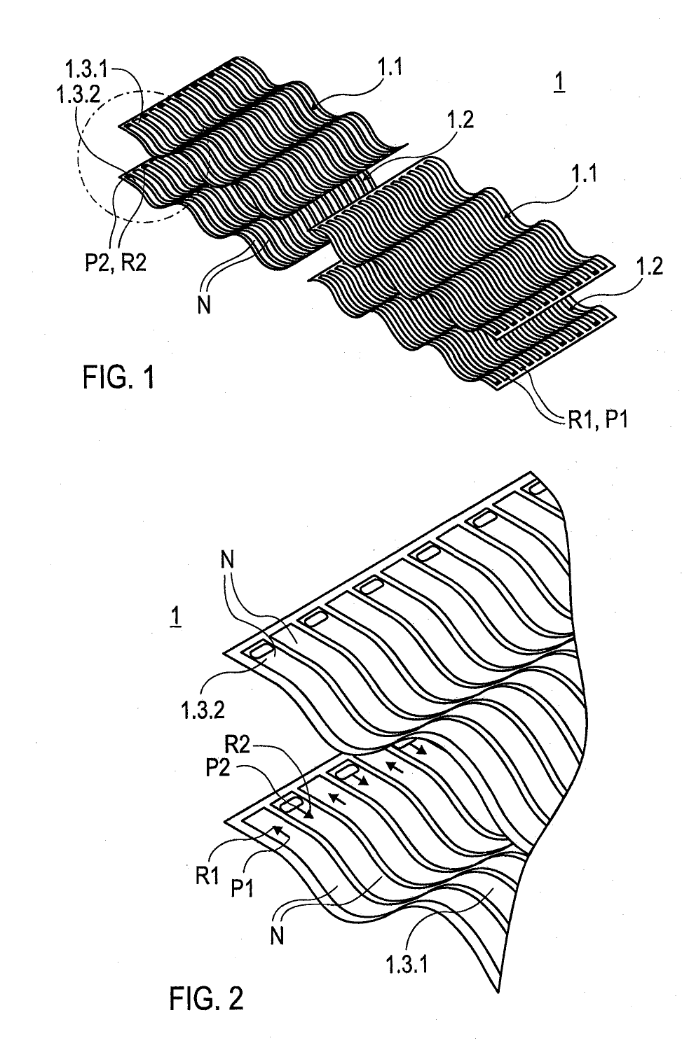

FIG. 1 flow channels of a heat exchanger unit schematically in an exploded view,

FIG. 2 a section II of the flow channels according to FIG. 1 in the circulation region at the end of the flow channels schematically in an exploded view,

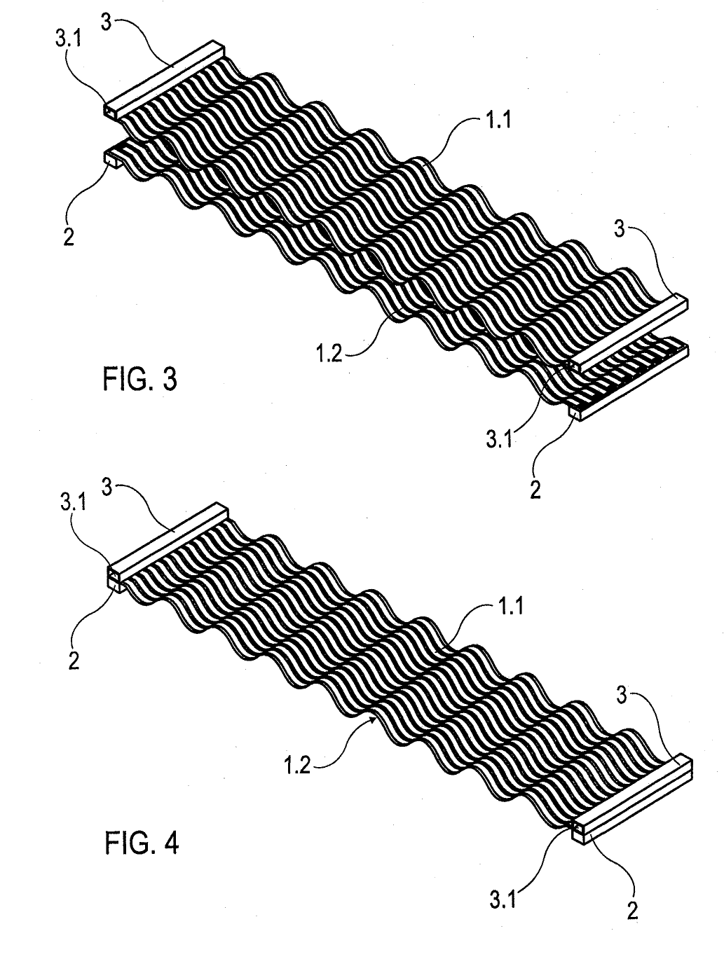

FIG. 3 the flow channels of the heat exchanger unit with flow distributor channels and return flow collection channels arranged in the flow-around region of the flow channels schematically in an exploded view,

FIG. 4 the flow channels according to FIG. 3 in the assembled state schematically in perspective,

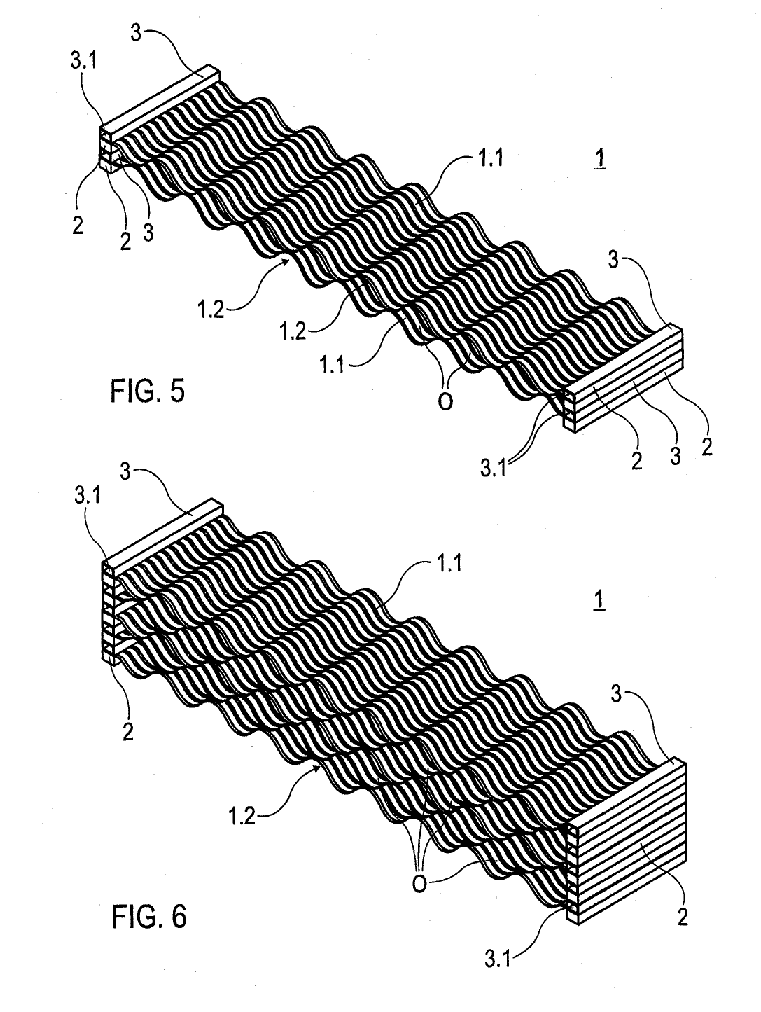

FIG. 5 a heat exchanger unit for 9 storage cells in the region of the flow channels schematically in perspective,

FIG. 6 a heat exchanger unit for 34 storage cells in the region of the flow channels schematically in perspective,

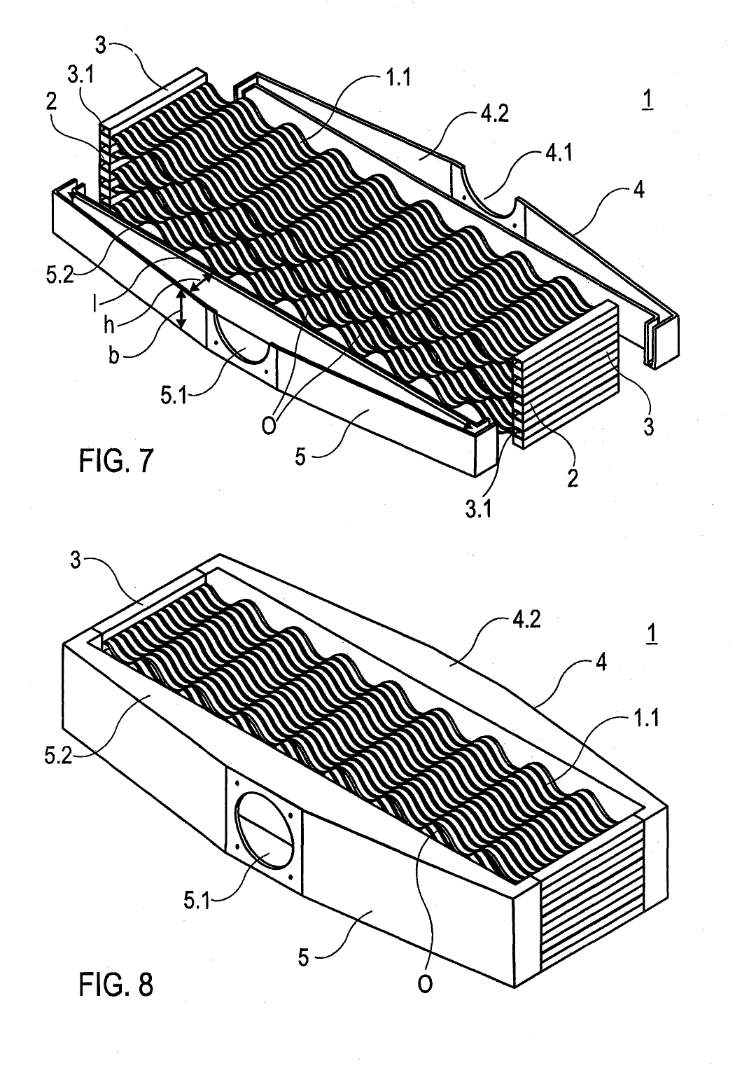

FIG. 7 a heat exchanger unit with flow channels, flow distributor channels, return flow collection channels and flow distributors and return flow collectors with respectively centrally arranged supply or drain openings schematically in an exploded view,

FIG. 8 the heat exchanger unit according to FIG. 7 in the assembled state schematically in perspective,

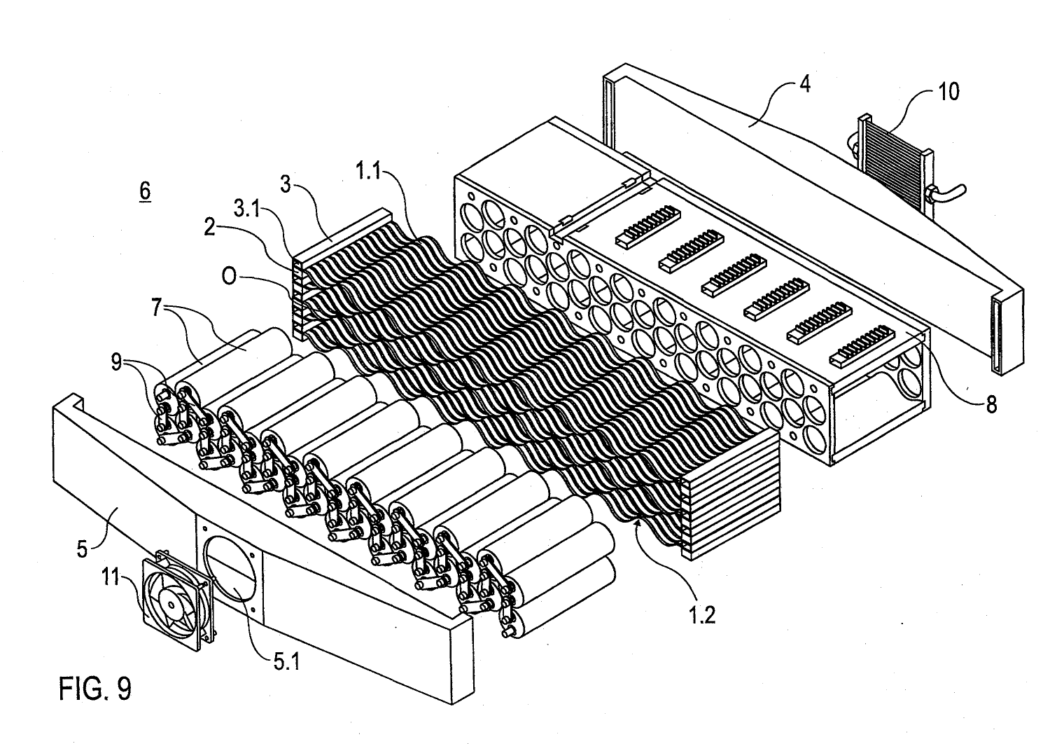

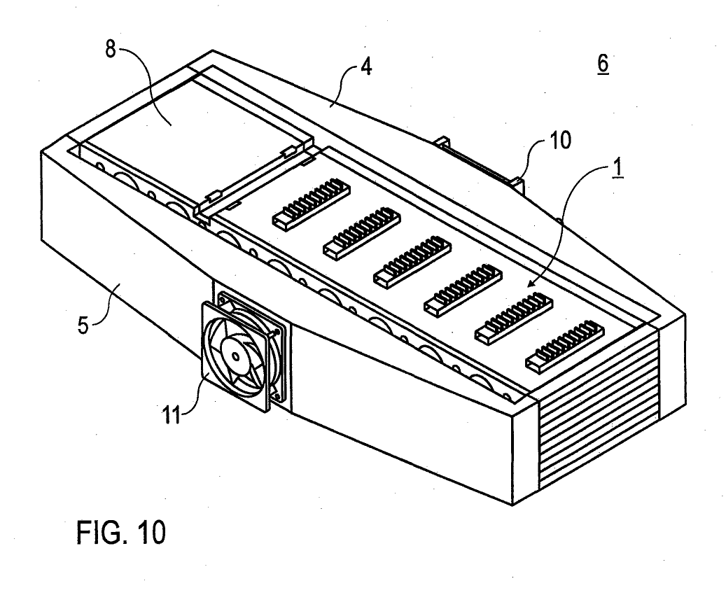

FIG. 9 an electrochemical energy accumulator with a heat exchanger unit and storage cells inserted therein schematically in an exploded view,

FIG. 10 the energy accumulator according to FIG. 9 in the assembled state schematically in perspective,

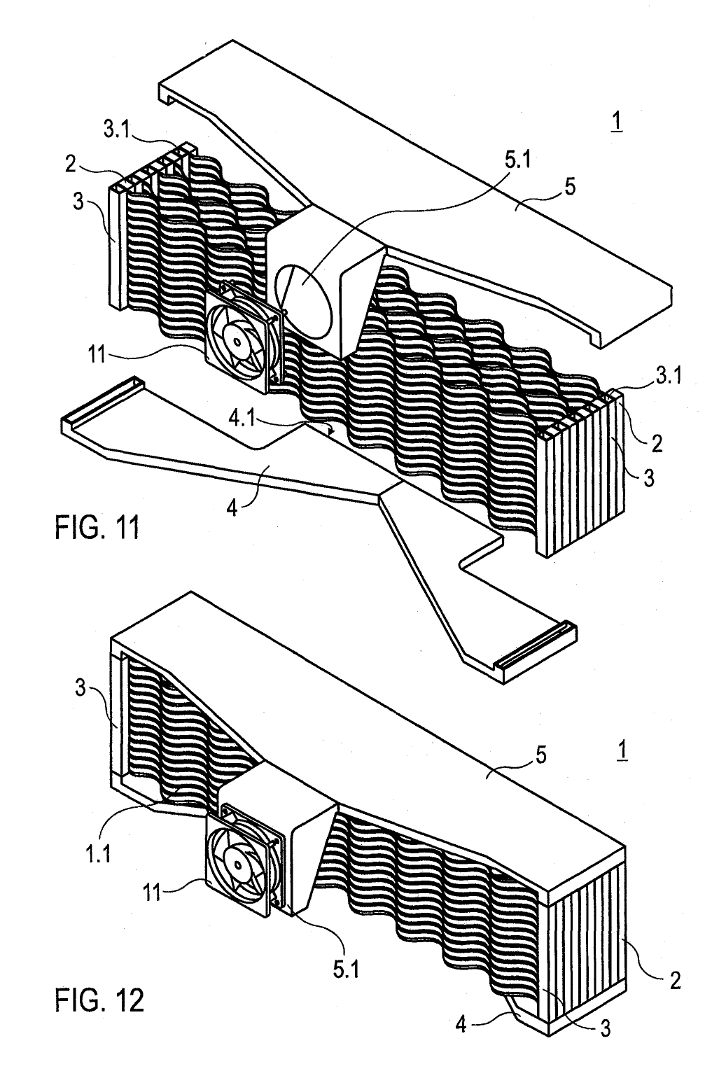

FIG. 11 an alternative embodiment for a heat exchanger unit with an alternative flow distributor and return flow collector schematically in an exploded view, and

FIG. 12 the heat exchanger unit according to FIG. 11 in the assembled state schematically in perspective.

Corresponding parts are provided with the same reference numerals in all figures.

FIG. 1 shows flow channels 1.3 for a heat exchanger unit 1 between two flow plates 1.1 and 1.2 which are formed by grooves N brought into these schematically in an exploded view. The flow plates 1.1 and 1.2 are for example formed by deep drawing two material strips or plates, into which the flow channels 1.3.1, 1.3.2 are brought.

The flow channels 1.3 are alternatively flown through by a temperature control medium in different flow directions R1 and R2 according to the arrows P1 or P2, especially a cooling medium, e.g. air or water. The flow channels 1.3.1 proceeding in the flow direction R1 thereby for example serve as flow channels (in the following called flow channels 1.3.1), and the flow channels 1.3.2 proceeding in the flow direction R2 as return flow channels (in the following called return flow channels 1.3.2).

In FIG. 3 are additionally shown the flow distributor channels 2 and the return flow collection channels 3 arranged at the ends of the flow channels 1.3.1 and the return flow channels 1.3.2. For the return flow collection channels 3, their return flow openings 3.1 are additionally shown. FIG. 4 shows the flow channels 1.3.1 and 1.3.2 according to FIG. 3 in the assembled state. The flow plates 1.1 and 1.2 are thereby for example welded or soldered to each other at least in the edge and web region in a fluid-tight manner.

FIG. 5 shows a heat exchanger unit 1 in perspective with wave-shaped flow plates 1.1 and 1.2 for forming internal flow channels 1.3.1, 1.3.2, wherein pairs of flow plates 1.1 and 1.2 are stacked on each other in such a manner that their wave troughs are placed on each other, so that their wave elevations are opposite each other and form recesses O, in which storage cells, not shown in detail, can be received (in the example according to FIG. 5 eight or nine storage cells).

The heat exchanger unit 1 according to FIG. 5 is for example suitable for an energy accumulator formed as a lithium ion battery with nine lithium ion cells with an output between 9 kW and 14 kW. It can also be a nickel metal hydride battery. The electrochemical energy accumulator is preferably used for the board current supply of a vehicle and/or for the current supply of a drive device of a vehicle. A gaseous medium, especially air is especially used as temperature control medium. A liquid medium, especially a cooling medium such as water can alternatively also be used. The heat exchanger unit 1 can also serve for the simultaneous cooling of an electronics unit for controlling and/or regulating and monitoring the charging and discharging process of the associated energy accumulator.

FIG. 6 shows a heat exchanger unit 1 for 34 storage cells with an output of maximum 55 kW schematically in perspective.

FIG. 7 shows a further embodiment for a heat exchanger unit 1 with internal flow channels 1.3.1, 1.3.2 and flow distributor channels 2 and return flow collection channels 3 arranged at the end sides thereof, which are fed by a flow distributor 4 or open into a return flow collector 5 schematically in an exploded view. According to the invention, a supply opening 4.1 is arranged centrally in the flow distributor 4 for a symmetrical distribution of the temperature control medium. A drain opening 5.1 is arranged centrally in the return flow collector 5. The flow distributor 4 and the return flow collector 5 respectively extend along the longitudinal extension of the heat exchanger unit 1, wherein the supply or discharge of the temperature control medium takes place via the supply or drain opening 4.1 or 5.1 perpendicular to the longitudinal extension, and the guide of the temperature control medium in the flow distributor 4 or the return flow collector 5 along the longitudinal extension. The centrally supplied temperature control medium is thereby divided into two flows with opposite flow direction, so that the ends of the flow channels 1.3.1 can be fed on both sides. Analogous to this, the returned temperature control medium is guided from both ends of the return flow channels 1.3.2 via the return flow collection channels 3 to the centrally arranged drain opening 5.1.

In the embodiment according to FIGS. 7 to 10, the flow distributor 4 and the return flow collector 5 are respectively formed as one channel, wherein one of the lateral surfaces of the flow distributor 4 and of the return flow collector 5 is formed in a funnel-shaped or cone-shaped manner. The flow distributor 4 and the return flow collector 5 are respectively formed as a single flat channel 4.2 or 5.2 for this, whose channel width b approximately corresponds to the height of the heat exchanger unit 1 and whose channel length l approximately corresponds to the length of the heat exchanger unit 1, wherein the channel height h (=channel depth) varies along the longitudinal extension of the flow channels 1.3.1, 1.3.2, and thus of the heat exchanger unit 1. The channel height thereby varies in such a manner that it increases from the respective channel end to the channel center, so that a funnel shape is formed centrally, that is, in the center point.

For supplying and discharging the temperature control medium into the flow distributor channels 2 or from the return flow collection channels 3, the ends of the flow distributor 4 or of the return flow collector 5 are angled and open into the flow distributor channels 2 or return flow collection channels 3.

For the symmetrical distribution or collection of the temperature control medium, guide elements, especially guide plates or deflection elements, in a manner not shown in detail, can be arranged in the supply opening 4.1 and in the drain opening 5.1.

FIG. 8 shows the heat exchanger unit 1 according to FIG. 7 in the assembled state schematically in perspective.

FIG. 9 shows an electrochemical energy accumulator 6 with a heat exchanger unit 1 according to FIGS. 7 and 8 and storage cells 7 inserted therein schematically in an exploded view. The heat exchanger unit 1 with the insertable storage cells 7 can thereby be surrounded by a fixing or support housing 8, which is correspondingly provided with transverse, longitudinal or other suitable stays.

The storage cells 7 can be connected to each other electrically in parallel and/or in series by means of cell connectors 9.

For the efficient cooling of the temperature control medium, an evaporator 10 is arranged on the flow input side at the supply opening 4.1, and for the efficient discharge, a blower 11 is arranged at the drain opening 5.1 on the flow output side.

FIG. 10 shows the energy accumulator 6 according to FIG. 9 in the assembled state schematically in perspective.

During the operation of the energy accumulator 6, cooled interior air is for example directly supplied to the supply opening 4.1, or, in the case of the use of exterior air or fresh air, it is cooled indirectly by the evaporator 10 and is distributed to the flow distributor channels 2 and the flow channels 1.3.1 via the flow distributor 4 for cooling the storage cells 7. The flow channels 1.3.1 are thereby flown through by the cooled temperature control medium—the fresh air or the cooled interior air—in alternating directions. The flow channels 1.3.1, 1.3.2 are especially flown through with a flow direction R1, R2 changing in a plane and a flow direction R1, R2 changing over parallel planes, as shown in more detail in FIG. 1, and thus in the counterflow principle. The heated air in the return flow channels 1.3.2 is supplied to the return flow collection channels 3 on the end side, from where the heated air is discharged into the the return flow collector 5, and is discharged to the environment via the drain opening 5.1 and the blower 11, e.g. an axial flow fan.

FIG. 11 shows an alternative embodiment for a heat exchanger unit 1 with an alternative flow distributor 4 and return flow collector 5 schematically in an exploded view. FIG. 12 shows the heat exchanger unit 1 according to FIG. 11 in the assembled state schematically in perspective. The flow distributor 4 and the return flow collector 5 thereby respectively have a flat channel 4.2, 5.2 with a constant channel height h. The channel width b varies in such a manner that it widens or diminishes in the direction of the channel center, where the supply opening 4.1 or the drain opening 5.1 are arranged perpendicular to the channel progression.

1. Heat exchanger unit (1) for an electrochemical energy accumulator (6), comprising flow channels (1.3.1, 1.3.2), through which a temperature control medium flows, which are provided with flow distributor channels (2) or return flow collector channels (3) supplying these or collecting from these on the end side, wherein a flow distributor (4) is connected upstream of the flow distributor channels (2), and a return flow collector (5) is connected downstream of the return flow collection channels (3),
characterized in that
the flow distributor (4) and the return flow collector (5) are arranged separate and opposite one another, wherein a supply opening (4.1) is located centrally on one of the lateral surfaces of the flow distributor (4) and a drain opening (5.1) is located centrally on one of the lateral surfaces of the return flow collector (5).

2. Heat exchanger unit according to claim 1,
characterized in that
the flow distributor (4) and the return flow collector (5) perdendicular to the longitudinal extension of the flow channels (1.3.1, 1.3.2) extend laterally at the outer flow channels (1.3.1, 1.3.2) opposite to each other over the entire length of the flow channels (1.3.1, 1.3.2).

3. Heat exchanger unit according to claim 1 or 2,
characterized in that
the flow distributor (4) and the return flow collector (5) are respectively formed as one channel.

4. Heat exchanger unit according to one of claims 1 to 3,
characterized in that
the flow distributor (4) and the return flow collector (5) are formed rectangular in their cross section.

5. Heat exchanger unit according to one of claims 1 to 4,
characterized in that
the flow distributor (4) and the return flow collector (5) are formed in the shape of a funnel or a cone.

6. Heat exchanger unit according to claim 5,
characterized in that
the flow distributor (4) and the return flow collector (5) are respectively formed as a single flat channel, whose channel width (b) approximately corresponds the height of the heat exchanger unit (1) and whose channel length (l) approximately corresponds to the length of the heat exchanger unit (1) and whose channel height (h) varies along the longitudinal extension.

7. Heat exchanger unit according to claim 6,
characterized in that
the channel height (h) of the respective flat channel increases from the respective channel end to the channel center.

8. Heat exchanger unit according to claim 7,
characterized in that
the supply opening (4.1) is arranged in the region of the channel center of the flow distributor (4), and the drain opening (5.1) is arranged in the region of the channel center of the return flow collector (5).

9. Heat exchanger unit according to one of claims 1 to 4,
characterized in that
the flow distributor (4) and the return flow collector (5) are respectively formed as a flat channel with a constant channel height (h) and varying channel width (b), wherein the supply opening $.1) opens into the flow distributor (4) or the drain opening (5.1) exits from the return flow collector (5) in the channel center perpendicular to the channel progression.

10. Heat exchanger according to claim 9,
characterized in that
the supply opening (4.1) and the drain opening (5.1) are respectively formed in a funnel-shaped manner.

11. Heat exchanger unit according to one of claims 1 to 10,
characterized in that
an evaporator (10) is arranged in the supply opening (4.1) on the flow input side.

12. Heat exchanger unit according to one of claims 1 to 12,
characterized in that
a blower (11), especially an axial flow fan, is connected downstream in the drain opening (5.1) on the flow output side.

13. Heat exchanger unit according to one of claims 1 to 12,
characterized in that
the flow channels (1.3.1, 1.3.2) are formed in the shape of waves.

14. Electrochemical energy accumulator (6) with a heat exchanger unit according to one of claims 1 to 13, in which several electrochemical storage cells (7) are arranged.

15. Use of an electrochemical energy accumulator (6) according to claim 14 for the board current supply of a vehicle and/or for the current supply of a drive device of a vehicle.

16. Use according to claim 15,
characterized in that
the vehicle is a road vehicle having one or several types of drive, one of which comprises an electric drive.
